(19) United States
(12) Patent Application Publication
(10) Pub. No.: US 2021/0156350 A1
(43) Pub. Date: May 27, 2021

(54) FUEL SUPPLY PUMP AND METHOD FOR MANUFACTURING FUEL SUPPLY PUMP

(71) Applicant: Hitachi Automotive Systems, Ltd., Hitachinaka-shi, Ibaraki (JP)

(72) Inventors: Shunsuke ARITOMI, Tokyo (JP); Masayuki SUGANAMI, Hitachinaka-shi (JP)

(73) Assignee: Hitachi Automotive Systems, Ltd., Hitachinaka-shi, Ibaraki (JP)

(21) Appl. No.: 17/046,853

(22) PCT Filed: Feb. 13, 2019
(86) PCT No.: PCT/JP2019/004953

§ 371 Date: Oct. 12, 2020

(30) Foreign Application Priority Data
Apr. 27, 2018 (JP) 2018-086044

(51) Int. Cl. F02M 63/02; F02M 63/00

(52) U.S. Cl. CPC F02M 63/0225; F02M 59/466; F02M 63/005

(57) ABSTRACT

An object of the invention is to provide a fuel supply pump that can simultaneously prevent cavitation erosion in a relief valve seat portion at the time of increasing the pressure and reduce a maximum pressure when releasing an abnormally high pressure. Therefore, in the fuel supply pump, a relief valve mechanism includes a seat portion and a relief valve seated on the seat portion, and sets a set discharge pressure to 30 MPa or more. A seat angle of the seat portion is formed to be 40° to 50°, and a set valve opening pressure of the relief valve mechanism is set to 2 MPa or more than the set discharge pressure.

### TECHNICAL FIELD

The present invention relates to a fuel supply pump and a method of manufacturing the fuel supply pump.

### BACKGROUND ART

In hydraulic equipment such as pumps, a direct-acting relief valve that regulates a relief pressure by a spring for pushing a valve body is widely adopted, and it is known that the opening angle of the seat surface affects the seating performance and sealing performance of the valve body (for example, see PTL 1).

In this PTL 1, there is the description “most of the valve portion of the valve body is a ball or a ball shape, 50° to 70° are preferable for the opening angle of the seat surface on which the valve seats from the meaning of improving both the seating performance and sealing performance, and usually set to 60°”.

### CITATION LIST

### Patent Literature

PTL 1: JP 2002-295701 A

### SUMMARY OF INVENTION

### Technical Problem

In the technique disclosed in PTL 1, the opening angle of the seat surface (called a seat angle) is defined. However, if the relief pressure (called the set valve opening pressure) is not set properly, the sealing performance cannot be maintained, and leakage may occur, leading to cavitation erosion.

An object of the invention is to provide a fuel supply pump that suppresses cavitation erosion in the relief valve seat portion when the pressure is increased.

### Solution to Problem

In order to achieve the above object, the invention provides a fuel supply pump which includes a relief valve mechanism. The relief valve mechanism includes a seat portion and a relief valve seated on the seat portion, and sets a set discharge pressure to 30 MPa or more. A seat angle of the seat portion is formed to be 40° to 50°, and a set valve opening pressure of the relief valve mechanism is set to 2 MPa or more than the set discharge pressure.

### Advantageous Effects of Invention

According to the invention, it is possible to provide a fuel supply pump that suppresses cavitation erosion in the relief valve seat portion when the pressure is increased. Objects, configurations, and effects besides the above description will be apparent through the explanation on the following embodiments.

### BRIEF DESCRIPTION OF DRAWINGS

FIG. 1 is a vertical cross-sectional view of a fuel supply pump for implementing the invention when viewed from a lateral direction.

FIG. 2 is a horizontal cross-sectional view of the fuel supply pump for implementing the invention when viewed from above.

FIG. 3 is a vertical cross-sectional view of the fuel supply pump for implementing the invention when viewed from a lateral direction different from FIG. 1.

FIG. 4 is an enlarged cross-sectional view of a relief valve mechanism according to a first embodiment of the invention and a periphery of a seat member thereof.

FIG. 5 is a graph illustrating the relationship between a seat contact surface pressure and a difference between a valve opening pressure and a discharge pressure in the first embodiment of the invention.

FIG. 6 is a graph illustrating an established range when the discharge pressure is 35 MPa in the relief valve mechanism according to the first embodiment of the invention.

FIG. 7 is a graph illustrating a time history of pressure pulsations around the relief valve mechanism in a second embodiment of the invention.

FIG. 8 is an enlarged cross-sectional view of an electromagnetic suction valve mechanism mounted on the fuel supply pump of this embodiment of the invention.

FIG. 9 is a configuration diagram of a fuel supply system including the fuel supply pump of this embodiment of the invention.

### DESCRIPTION OF EMBODIMENTS

Hereinafter, embodiments of the invention will be described using the drawings. In the following description, the vertical direction in the drawings may be specified and described, but this vertical direction does not mean the vertical direction when a fuel supply pump is mounted.

### First Embodiment

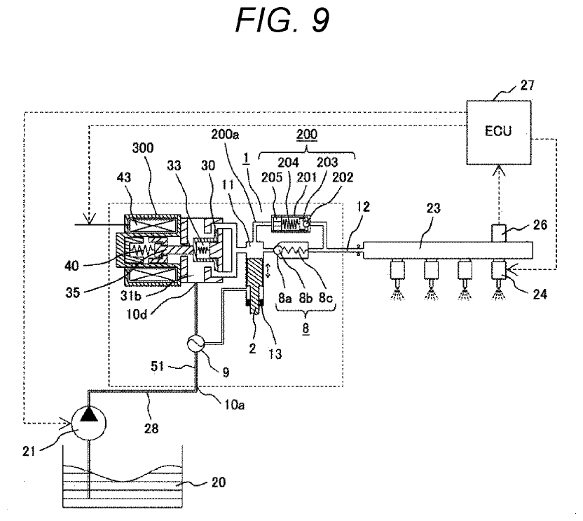

FIG. 9 is a configuration diagram illustrating an example of a fuel supply system including a fuel supply pump. A portion surrounded by a broken line indicates a pump body 1 of the fuel supply pump, and the mechanisms/components illustrated in the broken line are integrally assembled in the pump body 1 of the fuel supply pump.

The fuel of a fuel tank 20 is pumped up by a feed pump 21 on the basis of a signal from an engine control unit (ECU) 27. The fuel is pressurized to an appropriate feed pressure to be passed through a suction pipe 28, and sent to a low-pressure fuel suction port 10a of the fuel supply pump. The fuel passing from the low-pressure fuel suction port 10a through a suction joint 51 reaches a suction port 31b of an electromagnetic suction valve mechanism 300 of a capacity variation mechanism through a pressure pulsation damping mechanism 9 and a suction passage 10d.

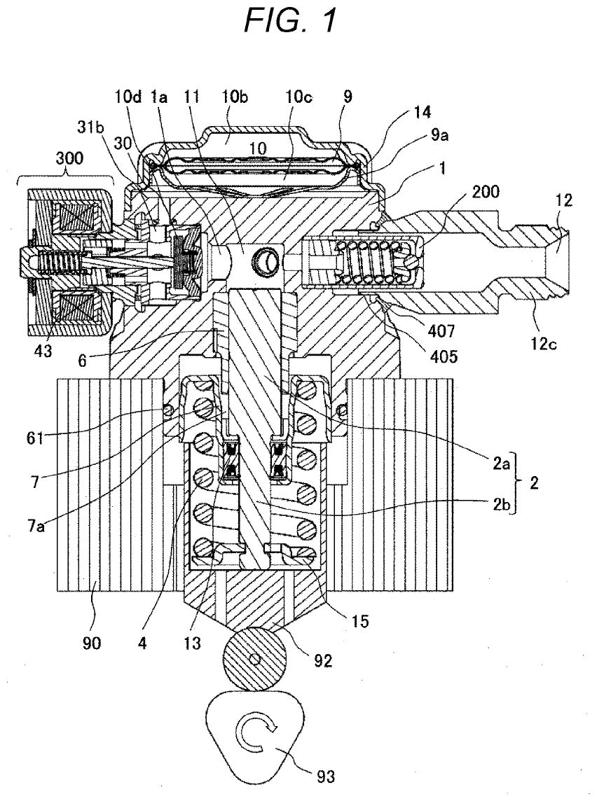

The fuel flowing to the electromagnetic suction valve mechanism 300 passes through a suction valve 30 and flows into a pressurizing chamber 11. A plunger 2 is applied with power of a reciprocating motion by a cam mechanism 93 (see FIG. 1) of an engine. In a downward stroke of the plunger 2, the fuel is sucked from the suction valve 30 by the reciprocating motion of the plunger 2. The fuel is pressurized in an upward stroke. The pressurized fuel is sent through a discharge valve mechanism 8 to a common rail 23 on which a pressure sensor 26 is mounted.

On the common rail 23, an injector 24 (so-called direct injector) for directly injecting fuel into a cylinder of an engine (not illustrated) and a pressure sensor 26 are mounted. The direct injectors 24 are mounted in accordance with the number of cylinders (cylinders) of the engine, open and close according to control signals from the ECU 27, and inject fuel into the cylinders. The fuel supply pump (fuel supply pump) of this embodiment is applied to a so-called direct injection engine system in which the injector 24 directly injects fuel into a cylinder of the engine.

When an abnormally high pressure is generated in the common rail 23 due to a failure of the direct injector 24 or the like, and the differential pressure between the pressure of a fuel discharge port 12 of the fuel supply pump and the pressure of the pressurizing chamber 11 is equal to or more than the valve opening pressure of a relief valve mechanism 200, a relief valve 202 opens. In this case, the abnormally high pressure fuel of the common rail 23 passes through the inside of the relief valve mechanism 200, and is returned from a relief passage 200a to the pressurizing chamber 11. This makes it possible to protect the common rail 23 (high-pressure pipe). This system is called a high pressure return system. The invention can be similarly applied to a low pressure return system in which the relief passage 200a is connected to a low-pressure fuel chamber 10, the suction passage 10d, or the like (see FIG. 1), and the abnormally high pressure fuel is returned to the low-pressure passage.

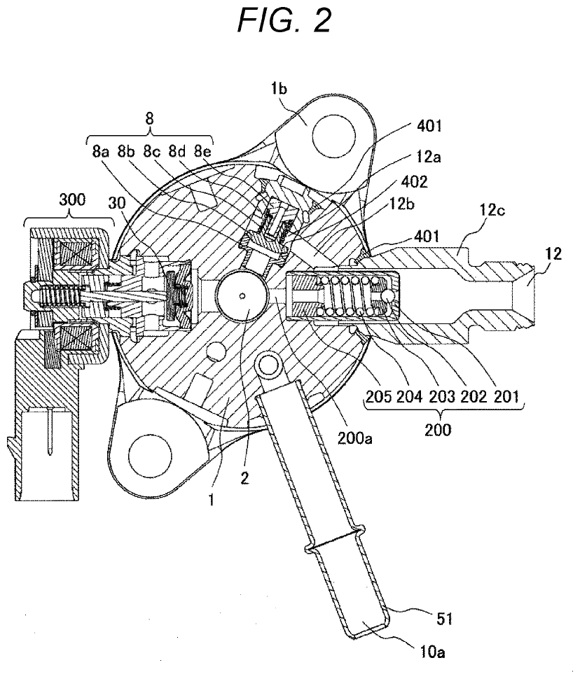

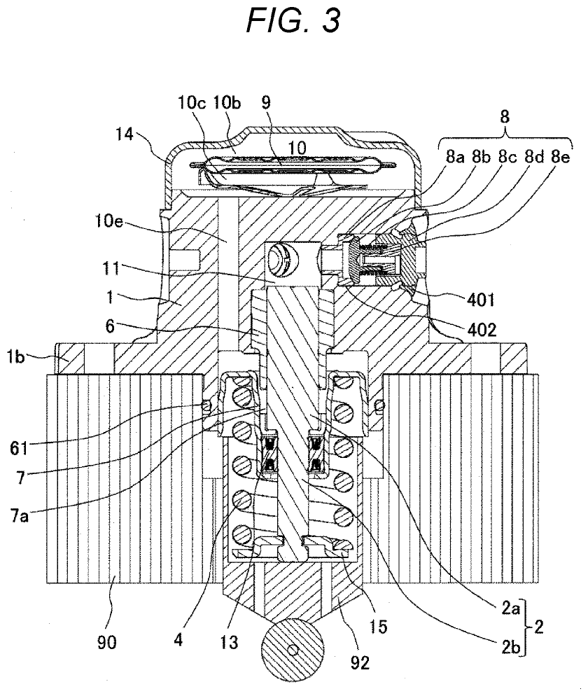

The fuel supply pump of this embodiment will be described with reference to FIGS. 1, 2 and 3. FIG. 1 is a cross-sectional view illustrating a cross section of the fuel supply pump of this embodiment, which is parallel to the center axial direction of the plunger 2. FIG. 2 is a horizontal cross-sectional view when viewed from above the fuel supply pump of this embodiment. FIG. 3 is a cross-sectional view of the fuel supply pump of this embodiment viewed from a direction different from FIG. 1.

Although the suction joint 51 is provided on the side surface of the body in FIG. 2, the invention is not limited to this, and is also applicable to a fuel supply pump in which the suction joint 51 is provided on the upper surface of a damper cover 14. The suction joint 51 is connected to a low-pressure pipe for supplying fuel from the fuel tank 20 of the vehicle, and the fuel flowing from the low-pressure fuel suction port 10a of the suction joint 51 flows through a low-pressure flow path formed inside the pump body 1. At the inlet of a fuel passage formed in the pump body 1, a suction filter (not illustrated) press-fitted into the pump body 1 is provided, and the suction filter prevents foreign substances present between the fuel tank 20 and the low-pressure fuel suction port 10a from flowing into the fuel supply pump.

The fuel flows upward from the suction joint 51 in the axial direction of the plunger, and flows into the low-pressure fuel chamber 10 formed by an upper damper portion 10b and a lower damper portion 10c illustrated in FIG. 1. The low-pressure fuel chamber 10 is formed by being covered by a damper cover 14 attached to the pump body 1. The fuel whose pressure pulsation has been reduced by the pressure pulsation damping mechanism 9 in the low-pressure fuel chamber 10 reaches the suction port 31b of the electromagnetic suction valve mechanism 300 via the low-pressure fuel flow path 10d. The electromagnetic suction valve mechanism 300 is attached to a lateral hole formed in the pump body 1 and supplies a desired flow rate of fuel to the pressurizing chamber 11 through a pressurizing chamber inlet flow path 1a formed in the pump body 1. An O-ring 61 is fitted to the pump body 1 to seal between a cylinder head 90 and the pump body 1, and prevents engine oil from leaking out.

As illustrated in FIG. 1, a cylinder 6 for guiding the reciprocating motion of the plunger 2 is attached to the pump body 1. The cylinder 6 is fixed to the pump body 1 on the outer peripheral side by press fitting and swagging. The surface of the cylindrical press-fitting portion of the cylinder 6 seals so as not to leak the pressurized fuel from the gap between the cylinder 6 and the pump body 1 to the low-pressure side. The upper end surface of the cylinder 6 is brought into contact with the plane of the pump body 1 in the axial direction to form a double sealing structure in addition to the sealing of the cylindrical press-fitting portion between the pump body 1 and the cylinder 6.

In the lower end of the plunger 2, there is provided a tappet 92 which converts a rotation motion of a cam 93 mounted in a cam shaft of the internal combustion engine into an up-down motion, and transmits the up-down motion to the plunger 2. The plunger 2 is tightly pressed to the tappet 92 by a spring 4 through a retainer 15. With this configuration, the plunger 2 can make a reciprocating motion in the vertical direction according to the rotation motion of the cam 93.

In addition, a plunger seal 13 held in the lower end portion of the inner periphery of a seal holder 7 is placed to come into slidable contact with the outer periphery of the plunger 2 in the lower portion in the drawing of the cylinder 6. With this configuration, when the plunger 2 slides, the fuel in an auxiliary chamber 7a is sealed, and prevented from flowing into the internal combustion engine. At the same time, the plunger seal 13 prevents lubricating oil (also including the engine oil) for lubricating the sliding portion in the internal combustion engine from flowing into the pump body 1.

As illustrated in FIG. 2, the pump body 1 is formed with a lateral hole for mounting the electromagnetic suction valve mechanism 300, a lateral hole for mounting the discharge valve mechanism 8 at the same position in the plunger axial direction, a lateral hole for further mounting the relief valve mechanism 200, and a lateral hole for mounting a discharge joint 12c. The discharge joint 12c is inserted into the lateral hole of the pump body 1 and fixed by welding at a welding portion 401. The fuel pressurized in the pressurizing chamber 11 via the electromagnetic suction valve mechanism 300 flows through a discharge passage 12b via the discharge valve mechanism 8, and is discharged from the fuel discharge port 12 of the discharge joint 12c.

The discharge valve mechanism 8 (FIGS. 2 and 3) provided in the outlet side of the pressurizing chamber 11 is configured by a discharge valve seat 8a, a discharge valve 8b which comes into contact with or separates from the discharge valve seat 8a, a discharge valve spring 8c which biases the discharge valve 8b toward the discharge valve seat 8a, a discharge valve plug 8d, and a discharge valve stopper 8e which determines a stroke (moving distance) of the discharge valve 8b.

The discharge valve plug 8d and the pump body 1 are joined by the welding portion 401, and this joining portion shuts off the inside space through which fuel flows and the outside. The discharge valve seat 8a is joined to the pump body 1 by a press-fitting portion 402.

In a state where there is no differential pressure between the fuel pressure of the pressurizing chamber 11 and the fuel pressure of a discharge valve chamber 12a, the discharge valve 8b is tightly pressed to the discharge valve seat 8a by the urging force of the discharge valve spring 8c, and enters a valve-closed state. Only when the fuel pressure of the pressurizing chamber 11 becomes larger than that of the discharge valve chamber 12a, the discharge valve 8b is opened against the discharge valve spring 8c. Then, a high-pressure fuel in the pressurizing chamber 11 is discharged to the common rail 23 through the discharge valve chamber 12a, the fuel discharge passage 12b, and the fuel discharge port 12. When being opened, the discharge valve 8b comes into contact with the discharge valve stopper 8e, and the stroke is restricted.

Therefore, the stroke of the discharge valve 8b is appropriately determined by the discharge valve stopper 8e. With this configuration, it is possible to prevent the fuel discharged at a high pressure to the discharge valve chamber 12a from flowing back into the pressurizing chamber 11 because of delay in the close of the discharge valve 8b due to excessively large stroke. Therefore, deterioration in efficiency of the fuel supply pump can be suppressed. In addition, when the discharge valve 8b repeatedly opens and closes, the discharge valve 8b is guided by the outer peripheral surface of the discharge valve stopper 8e such that the discharge valve 8b moves only in the stroke direction.

As described above, the pressurizing chamber 11 is configured by the pump body 1, the electromagnetic suction valve mechanism 300, the plunger 2, the cylinder 6, and the discharge valve mechanism 8. As illustrated in FIGS. 2 and 3, the fuel supply pump according to this embodiment uses a mounting flange 1b provided on the pump body 1 to closely adhere to the plane of the cylinder head 90 of the internal combustion engine, and is fixed by a plurality of bolts (not illustrated).

The relief valve mechanism 200 includes a seat member 201, the relief valve 202, a relief valve holder 203, a relief spring 204, and a holder member 205. The relief valve mechanism 200 is a valve that is configured to operate when an abnormally high pressure occurs due to some problem in the common rail 23 or a member near before. When the pressure in the common rail 23 or the member near before becomes high, the valve is opened to return the fuel to the pressurizing chamber 11 or the low-pressure passage (the low-pressure fuel chamber 10 or the suction passage 10d). Therefore, it is necessary to maintain the valve-closed state below a predetermined pressure, and has the very strong spring 204 to oppose high pressure.

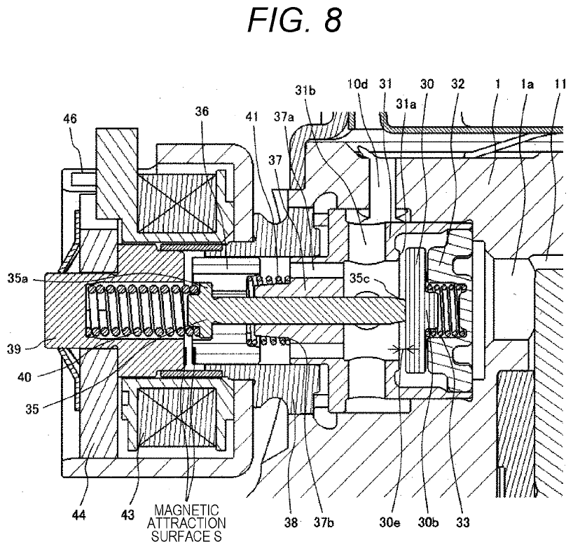

The electromagnetic suction valve mechanism 300 will be described with reference to FIG. 8. FIG. 8 is an enlarged cross-sectional view of the electromagnetic suction valve mechanism of this embodiment, illustrating a cross section parallel to the driving direction of the suction valve, and a cross-sectional view illustrating a state where the suction valve is opened.

In the non-energized state, the suction valve 30 is operated in the valve open direction by a strong rod urging spring 40, so that it is a normally open type. If a control signal from the ECU 27 is applied to the electromagnetic suction valve mechanism 300, the current flows to an electromagnetic coil 43 through a terminal 46. When a current flows through the electromagnetic coil 43, a movable core 36 is attracted in the valve closing direction on a magnetic attraction surface S by the magnetic attraction force of a magnetic core 39. The rod urging spring 40 is disposed in a concave portion formed in the magnetic core 39 and urges a flange portion 35a. The flange portion 35a is engaged with the concave portion of the movable core 36 on the side opposite to the rod urging spring 40.

The magnetic core 39 is configured to be in contact with a lid member 44 that covers the electromagnetic coil chamber in which the electromagnetic coil 43 is disposed. When the movable core 36 is attracted and moved by the magnetic core 39, the movable core 36 is engaged with the flange portion 35a of a rod 35, and the rod 35 moves together with the movable core 36 in the valve closing direction. Between the movable core 36 and the suction valve 30, a valve closing urging spring 41 for urging the movable core 36 in the valve closing direction, and a rod guide member 37 for guiding the rod 35 in the opening and closing valve direction are arranged. The rod guide member 37 forms a spring seat 37b of the valve closing urging spring 41. Further, the rod guide member 37 is provided with a fuel passage 37a, which allows the fuel to flow into and out of the space in which the movable core 36 is disposed.

The movable core 36, the valve closing urging spring 41, the rod 35 and the like are contained in an electromagnetic suction valve mechanism housing 38 fixed to the pump body 1. Further, the magnetic core 39, the rod urging spring 40, the electromagnetic coil 43, the rod guide member 37, and the like are held in the electromagnetic suction valve mechanism housing 38. The rod guide member 37 is mounted to the electromagnetic suction valve mechanism housing 38 on the side opposite to the magnetic core 39 and the electromagnetic coil 43, and includes the suction valve 30, a suction valve urging spring 33, and a stopper 32.

The suction valve 30, the suction valve urging spring 33, and the stopper 32 are provided on a side of the rod 35 opposite to the magnetic core 39. The suction valve 30 is formed with a guide portion 30b projecting toward the pressurizing chamber 11 and guided by the suction valve urging spring 33. The suction valve 30 moves in the valve open direction (the direction away from a valve seat 31a) by the gap of a valve body stroke 30e with the movement of the rod 35, and becomes a valve open state. The fuel is supplied from a supply passage 10d to the pressurizing chamber 11. The guide portion 30b stops moving by colliding with the stopper 32 fixed by being pressed into the housing (the rod guide member 37) of the electromagnetic suction valve mechanism 300. The rod 35 and the suction valve 30 are separate and independent structures. The suction valve 30 closes the flow path to the pressurizing chamber 11 by contacting the valve seat 31a of a valve seat member 31 disposed on the suction side, and opens the flow path to the pressurizing chamber 11 by separating from the valve seat 31a.

When the plunger 2 moves in the direction (lower direction) of the cam 93 and enters a suction stroke state while the cam 93 of FIG. 1 rotates, the volume of the pressurizing chamber 11 is increased and the fuel pressure in the pressurizing chamber 11 is lowered. When the electromagnetic coil 43 is de-energized during this suction stroke, the sum of the urging force of the rod urging spring 40 and the fluid force due to the pressure in the suction passage 10d becomes larger than the fluid force due to the fuel pressure in the pressurizing chamber 11. Thus, the suction valve 30 is urged by the rod 35 in the valve open direction to be in the valve open state.

When the plunger 2 reaches the bottom dead center and completes the suction stroke, the plunger 2 starts to move upward. Herein, the electromagnetic coil 43 keeps a non-energized state, and a magnetic urging force does not operate. The volume of the pressurizing chamber 11 is reduced according to the compression movement of the plunger 2. However, in this state, the fuel once sucked into the pressurizing chamber 11 returns to the suction passage 10d through the opening of the suction valve 30 which enters the valve open state again. Therefore, the pressure of the pressurizing chamber 11 is not increased. This stroke is called a returning stroke.

Thereafter, by turning on the energization of the electromagnetic coil 43 at a desired timing, the magnetic attraction force is generated as described above, so that the rod 35 moves in the valve closing direction together with the movable core 36, and a tip portion of the rod 30 is separated from the suction valve 30. In this state, the suction valve 30 is a check valve that opens and closes according to the differential pressure, and is closed by the urging force of the suction valve urging spring 33. After the suction valve 30 is closed, the plunger 2 is raised, so that the volume of the pressurizing chamber 11 is reduced, and the fuel is pressurized. This is called a compression stroke. When the fuel in the pressurizing chamber 11 is pressurized and the pressure of the fuel exceeds the sum of the fuel pressure in the discharge valve chamber 12a and the urging force of the discharge valve spring 8c, the discharge valve 8b opens to discharge the fuel.

The amount of the discharging high-pressure fuel can be controlled by controlling timing for energizing the electromagnetic coil 43 of the electromagnetic suction valve mechanism 300. If the timing for energizing the electromagnetic coil 43 is set to be advanced, the ratio of the returning stroke in the compression stroke becomes small, and the ratio of the discharge stroke becomes large. In other words, the fuel returning to the suction passage 10d becomes less, and the high-pressure fuel discharged to the common rail 23 becomes large. On the other hand, if the energizing timing is set to be delayed, the ratio of the returning stroke in the compression stroke becomes large, and the ratio of the discharge stroke becomes small. In other words, the fuel returning to the suction passage 10d becomes large, and the high-pressure fuel discharged to the common rail 23 becomes less. The timing for energizing the electromagnetic coil 43 is controlled by a command from the ECU 27.

As described above, it is possible to control the amount of high-pressure fuel to be discharged as much as the internal combustion engine requires by controlling the timing for energizing the electromagnetic coil 43.

In the low-pressure fuel chamber 10, the pressure pulsation damping mechanism 9 is provided to reduce the propagation of the pressure pulsation generated in the fuel supply pump to a fuel pipe 28. Above and below the pressure pulsation damping mechanism 9, an upper damper portion 10b and the lower damper portion 10c are provided at intervals. In a case where the fuel flown into the pressurizing chamber 11 returns to the suction passage 10d through the suction valve 30 which enters the valve open state again to control the volume, the pressure pulsation is generated in the low-pressure fuel chamber 10 by the fuel returned to the suction passage 10d. However, the pressure pulsation damping mechanism 9 provided in the low-pressure fuel chamber 10 is formed by metal diaphragm damper formed by bonding two disk-like metal plates of a corrugate shape at the outer periphery and with an inert gas such as argon injected therein, so that the pressure pulsation is absorbed and reduced as the metal damper expands and contracts. Reference numeral 9a denotes a mounting bracket for fixing the metal damper to the inner peripheral portion of the pump body 1, and is provided on the fuel passage. The support part with the damper is not a whole circumference but a part, so that the fluid can freely flow between the front and back of the mounting bracket 9a.

The plunger 2 includes a large diameter portion 2a and a small diameter portion 2b. The volume of the auxiliary chamber 7a is increased or decreased according to the reciprocating motion of the plunger 2. The auxiliary chamber 7a is connected to the low-pressure fuel chamber 10 by a fuel passage 10e (see FIG. 3). The fuel flows from the auxiliary chamber 7a to the low-pressure fuel chamber 10 when the plunger 2 descends. The fuel flows from the low-pressure fuel chamber 10 to the auxiliary chamber 7a when the plunger ascends.

With this configuration, the fuel flow rate to the inside and outside of the pump in the suction stroke or the returning stroke of the pump can be reduced, and the pressure pulsation generated in the fuel supply pump is reduced.

Further, the operation of the relief valve mechanism will be described in detail. As illustrated in FIG. 2, the relief valve mechanism 200 includes the seat member 201, the relief valve 202, the relief valve holder 203, the relief spring 204, and a relief spring stopper 205.

The relief valve 202, the relief valve holder 203, and the relief spring 204 are sequentially inserted into the seat member 201, and the relief spring stopper 205 is fixed by press fitting or the like. The pressing force of the relief spring 204 is defined by the position of the relief spring stopper 205. The set valve opening pressure of the relief valve 202 is set to a prescribed value by the pressing force of the relief spring 204. The unitized relief valve mechanism 200 is fixed to the pump body 1 by press fitting or the like as illustrated in FIG. 1. Further, although the unitized relief valve mechanism 200 is illustrated in FIG. 1, the invention is not limited to this.

The fuel supply pump needs to pressurize the fuel to a very high pressure of several MPa to several tens of MPa. In this embodiment, the maximum discharge pressure (for example, 30 MPa) that can be discharged by the fuel supply pump in normal operation is defined as the set discharge pressure. The set valve opening pressure of the relief valve 202 needs to be set to be equal to or higher than the set discharge pressure. This is because if the set valve opening pressure is set below the set discharge pressure, the relief valve 202 will open even if the fuel is normally pressurized by the fuel supply pump. This malfunction of the relief valve 202 may cause cavitation erosion near the seat portion of the seat member 201, decrease in discharge amount, decrease in energy efficiency, and the like. Further, even when the set valve opening pressure is set to be equal to or higher than the set discharge pressure, if the difference is small, the contact surface pressure of the seat portion 201a decreases, fuel leakage may occur, and cavitation erosion may occur. The degree of cavitation erosion becomes more serious as the fuel pressure increases, so this is a problem that became particularly apparent when the set discharge pressure is set high to 35 MPa compared to the related art where the set discharge pressure is set less than 30 MPa.

From the above, it is necessary to set the set valve opening pressure of the relief valve 202 to be higher than the set discharge pressure by a certain set value. However, this leads to an increase in the maximum pressure of the common rail 23 when an abnormally high pressure is generated and the relief valve 202 opens to release the fuel. In order to suppress the maximum pressure of the common rail 23, it is an important issue to suppress the increase in valve opening pressure to the necessary minimum. That is, in this embodiment, it is an object to simultaneously reduce the maximum pressure of the common rail 23 when opening the abnormally high pressure while suppressing the cavitation erosion in the seat portion of the relief valve 202 at the time of high pressure (for example, 35 MPa).

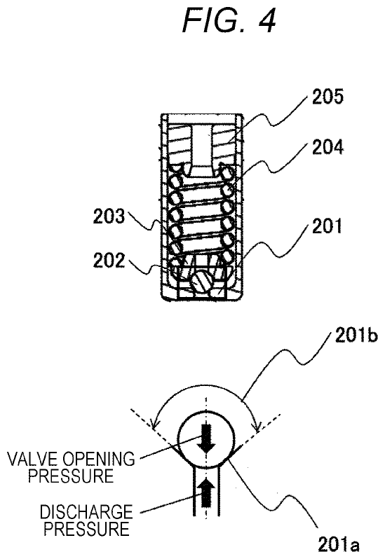

This embodiment for solving these problems will be described with reference to FIG. 4. The upper part of FIG. 4 illustrates a cross-sectional view of the relief valve mechanism 200 of this embodiment, and the lower part illustrates an enlarged cross-sectional view of the vicinity of a seat portion 201a surrounded by a frame line. The ball-shaped relief valve 202 and the conical slope formed on the seat member 201 contact each other to form a linear seat portion 201a. Here, the angle between the conical slopes is defined as a seat angle 201b. The lower side in the drawing is the upstream side across the seat portion 201a, and the set discharge pressure acts in the direction to open the relief valve 202. Against this, the valve opening pressure is set by the load of the relief spring 204 from the downstream side. The relief valve 202 is pressed against the seat member 201 due to the difference between the valve opening pressure and the set discharge pressure, and a contact surface pressure is generated in the seat portion 201a.

If the difference between the two is not sufficient, the contact surface pressure is also insufficient, which may cause fuel leakage and cavitation erosion.

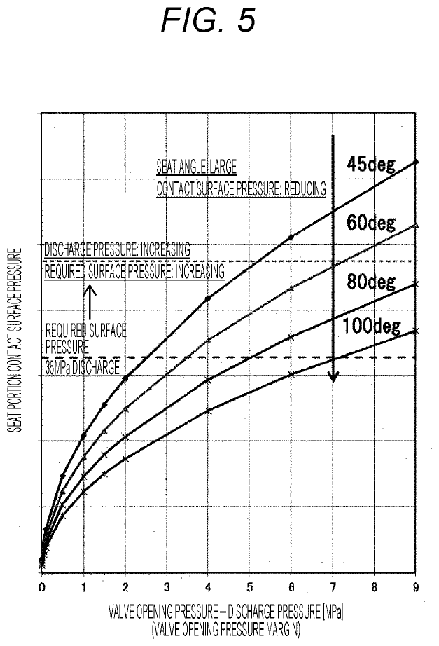

FIG. 5 illustrates a contact surface pressure generated in the seat portion 201a with respect to the difference between the valve opening pressure and the set discharge pressure (called a valve opening pressure margin). As the valve opening pressure margin increases, the seat contact surface pressure also increases. If the valve opening pressure margin is the same, the contact surface pressure decreases as the seat angle 201b increases. This is because, of the axial force pressing the relief valve 202 against the seat member 201, the normal force acting on the conical slope becomes smaller as the seat angle becomes larger. With respect to the contact surface pressure determined in this manner, a required surface pressure for preventing fuel leakage is determined by the fuel pressure for sealing, that is, the set discharge pressure, and the required surface pressure becomes larger as the set discharge pressure increases.

Therefore, in this embodiment, there is provided the relief valve mechanism 200 which includes the seat portion 201a and the relief valve 202 seated on the seat portion 201a. In the method of manufacturing the fuel supply pump in which the set valve opening pressure of the relief valve mechanism 200 is set to be higher than the set discharge pressure by a set value, the relief valve mechanism 200 is manufactured such that the set value becomes larger as the seat angle 201b of the seat portion 201a increases when the set discharge pressure is the same. That is, when manufacturing a fuel supply pump with a set discharge pressure of 35 MPa, the difference (set value) between the set valve opening pressure and the set discharge pressure is set to be high as the seat angle 201b of the seat portion 201a increases. Further, when the seat angle 201b of the seat portion 201a is the same, the relief valve mechanism 200 is manufactured such that the set value becomes larger as the set discharge pressure increases. Further, this set value is synonymous with the above-mentioned valve opening pressure margin.

In this way, by setting the set valve opening pressure according to the seat angle 201b and the set discharge pressure, it is expected that fuel leakage is prevented by maintaining the contact surface pressure of the seat portion 201a, and as a result, cavitation erosion is suppressed. In addition, the set valve opening pressure can be reduced as the seat angle 201b is reduced and the set discharge pressure is lowered, and the maximum pressure of the common rail 23 can be expected to be reduced when the abnormally high pressure is released.

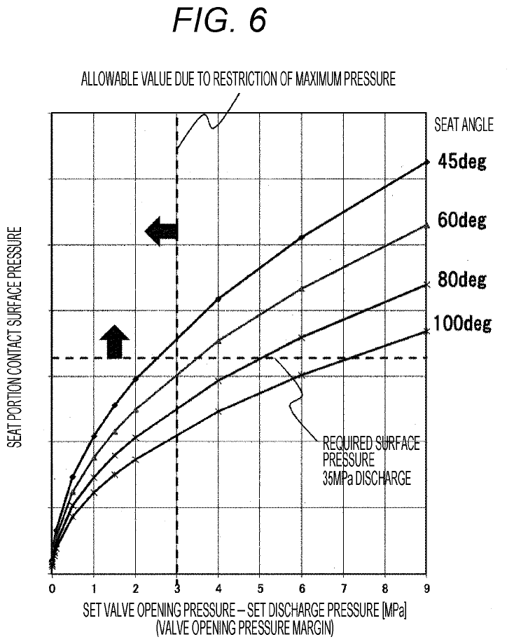

FIG. 6 illustrates a range in which the seat angle 201b and the valve opening pressure margin are satisfied, taking the case where the set discharge pressure is 35 MPa as an example. It has been found that cavitation erosion may occur particularly when the set discharge pressure is 35 MPa. Here, a case will be described in which the valve opening pressure margin needs to be kept within 3 MPa due to the restriction of the maximum pressure determined by the withstand pressure allowable value of each part. In this case, as illustrated in FIG. 6, it is necessary to reduce the seat angle 201b to about 45° in order to maintain the required surface pressure for sealing the fuel pressurized to 35 MPa.

That is, in this embodiment, the fuel supply pump includes the relief valve mechanism 200 which includes the seat portion 201a and the relief valve 202 seated on the seat portion 201a and sets the set discharge pressure to 30 MPa with the seat angle 201b as a median value. In the fuel supply pump, the seat angle 201b of the seat portion 201a is formed to be 40° to 50°, and the set valve opening pressure of the relief valve mechanism 200 is 2 MPa or larger than the set discharge pressure.

By doing this, even in a case where the set discharge pressure is 35 MPa in which cavitation erosion starts to become particularly severe due to high pressure, it can be expected that the fuel leakage is prevented by maintaining the contact surface pressure of the seat portion 201a, and eventually cavitation erosion is prevented.

### Second Embodiment

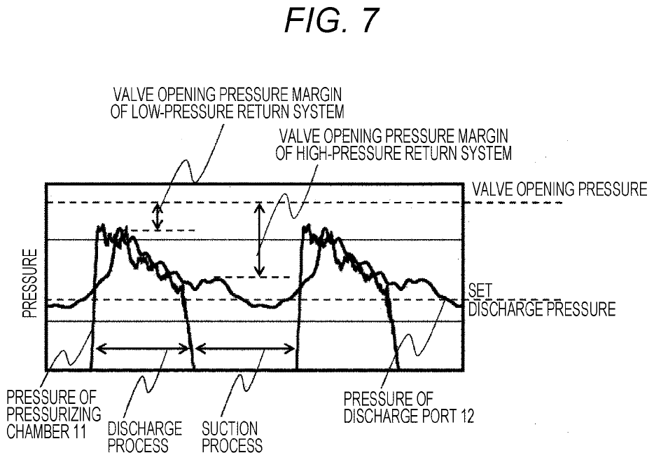

A second embodiment of the invention will be described using FIG. 7. FIG. 7 illustrates changes in the pressure of the pressurizing chamber 11 and the pressure of the discharge port 12 with the passage of time. Since the fuel supply pump periodically repeats discharge and suction, the internal pressure pulsates with respect to the set discharge pressure, especially at high rotation speeds. Therefore, it is possible to prevent cavitation erosion more reliably by adding the pulsating component to the set discharge pressure used in the first embodiment to set the valve opening pressure margin. Next, the difference between the pressure behavior of each part and the relief valve system will be described. In the discharge process, the pressure of the pressurizing chamber 11 is almost equal to the pressure of the discharge port 12, and in the suction process, the pressure of the pressurizing chamber 11 decreases, but the pressure of the discharge port 12 maintains the same pressure as the set discharge pressure.

Here, in the case of the high pressure return system, even if the pressure of the discharge port 12 acts on the upstream side of the relief valve 202 in the discharge process, the pressure of the pressurizing chamber 11 acts on the downstream side so as to oppose it, so that it is possible to maintain the seat contact surface pressure. On the other hand, since the pressure of the pressurizing chamber 11 is lowered in the suction process, the seat contact surface pressure is reduced most when the pressure of the discharge port 12 is maximized in the suction process.

Therefore, it is desirable that the seat surface pressure is maintained at or above the allowable surface pressure in this state.

On the other hand, in the case of the low pressure return system, the pressure of the pressurizing chamber 11 does not act on the downstream side of the relief valve 202, so that the seat contact surface pressure is reduced most when the pressure of the discharge port 12 becomes maximum in the discharge process. Therefore, it is desirable that the seat surface pressure is maintained at or above the allowable surface pressure in this state. From the above, in the case of the high pressure return system, it is desirable to define the difference between the maximum pressure value of the discharge port 12 and the set valve opening pressure in the suction process as the valve opening pressure margin. Further, in the case of the low pressure return system, it is desirable to define the difference between the maximum pressure value of the discharge port 12 and the set valve opening pressure in the discharge process as the valve opening pressure margin.

That is, the fuel supply pump of this embodiment includes the pressurizing chamber 11 for pressurizing the fuel. In a case where the relief valve mechanism 200 is configured to open the relief valve when the pressure difference between the pressure on the discharge side of the pressurizing chamber 11 (the pressure of the discharge port 12) and the pressure of the pressurizing chamber 11 becomes larger than the set valve opening pressure (in the case of the high pressure return system), it is desirable to set the set discharge pressure as the maximum pressure value on the discharge side of the pressurizing chamber 11 in the suction stroke. On the other hand, in a case where the relief valve mechanism is configured to open the relief valve when the pressure difference between the pressure on the discharge side of the pressurizing chamber 11 and the pressure on the suction side of the pressurizing chamber 11 becomes larger than the set valve opening pressure (in the case of the low pressure return system), it is desirable to set the set discharge pressure as the maximum pressure value on the discharge side of the pressurizing chamber 11 in the compression stroke. The suction side of the pressurizing chamber 11 in the case of the low pressure return system may be a low pressure space such as the low-pressure fuel chamber 10 formed by the lower damper portion 10c, the auxiliary chamber 7a, or a space communicating with the suction port 31b of the electromagnetic suction valve mechanism 300 in FIG. 1.

In other words, in the case of the high pressure return system, in the method of manufacturing the fuel supply pump of this embodiment, the relief valve mechanism 200 is configured to open the relief valve when the pressure difference between the pressure on the discharge side of the pressurizing chamber 11 and the pressure of the pressurizing chamber 11 becomes larger than the set valve opening pressure, and the set discharge pressure is set as the maximum pressure value on the discharge side of the pressurizing chamber 11 in the suction stroke. Further, in the case of the low pressure return system, in the method of manufacturing the fuel supply pump of this embodiment, the relief valve mechanism 200 is configured to open the relief valve when the pressure difference between the pressure on the discharge side of the pressurizing chamber 11 and the pressure on the suction side of the pressurizing chamber 11 becomes larger than the set valve opening pressure, and the set discharge pressure is set as the maximum pressure value on the discharge side of the pressurizing chamber 11 in the compression stroke.

By doing so, it can be expected that fuel leakage is prevented by maintaining the contact surface pressure of the seat portion 201a even when the pressure acting on the relief valve 202 pulsates with respect to the set discharge pressure, and as a result, cavitation erosion is more reliably prevented.

As described above, the fuel supply pump of this embodiment includes the relief valve mechanism 200 described above. The relief valve mechanism 200 is configured to return fuel to the pressurizing chamber 11 or the low-pressure passage (the low-pressure fuel chamber 10, the suction passage 10d, or the like) in a case where the fuel of the discharge port 12 on the downstream side of the discharge valve mechanism 8 exceeds a set pressure.

As described above, in addition to the relief valve mechanism 200, this embodiment can be applied to functional components for satisfying the performance of the fuel supply pump, for example, the electromagnetic suction valve mechanism 300 and the discharge valve mechanism 8, and also applicable even other functional components.

Although the description of the embodiments has been completed, the invention is not limited to the above-described embodiments and can be widely modified and implemented. For example, although the invention is applied to the fuel supply pump in the above embodiment, it may be applied to a hydraulic equipment that requires a check valve. The arrangement position and the arrangement method of the functional components in the fuel supply pump are not limited to the examples of the above embodiment.

### REFERENCE SIGNS LIST

1 pump body
2 plunger
6 cylinder
7 seal holder
8 discharge valve mechanism
200 relief valve mechanism
201 seat member
201a seat portion
201b seat angle
202 relief valve
203 relief valve holder
204 relief spring
205 spring holder
300 electromagnetic suction valve mechanism

1. A fuel supply pump, comprising:
a relief valve mechanism that includes a seat portion and a relief valve seated on the seat portion, and sets a set discharge pressure to 30 MPa or more,
wherein a seat angle of the seat portion is formed to be 40° to 50°, and a set valve opening pressure of the relief valve mechanism is set to 2 MPa or larger than the set discharge pressure.

2. The fuel supply pump according to claim 1, comprising
a pressurizing chamber that pressurizes fuel,
wherein the relief valve mechanism is configured to open the relief valve when a pressure difference between a pressure on a discharge side of the pressurizing chamber and a pressure of the pressurizing chamber becomes larger than the set valve opening pressure, and
wherein the set discharge pressure is set as a maximum pressure value on the discharge side of the pressurizing chamber in a suction stroke.

3. The fuel supply pump according to claim 1, comprising
a pressurizing chamber that pressurizes fuel,
wherein the relief valve mechanism is configured to open the relief valve when a pressure difference between a pressure on a discharge side of the pressurizing chamber and a pressure on a suction side of the pressurizing chamber becomes larger than the set valve opening pressure, and
wherein the set discharge pressure is set as a maximum pressure value on the discharge side of the pressurizing chamber in a compression stroke.

4. A method of manufacturing a fuel supply pump, the fuel supply pump including a relief valve mechanism that includes a seat portion and a relief valve seated on the seat portion, and sets a set valve opening pressure of the relief valve mechanism to be larger than a set discharge pressure by a set value,
the method comprising:
manufacturing the relief valve mechanism such that, in a case where the set discharge pressure is the same, the set value becomes larger as a seat angle of the seat portion increases.

5. A method of manufacturing a fuel supply pump, the fuel supply pump including a relief valve mechanism that includes a seat portion and a relief valve seated on the seat portion, and sets a set valve opening pressure of the relief valve mechanism to be larger than a set discharge pressure by a set value,
the method comprising:
manufacturing the relief valve mechanism such that, in a case where a seat angle of the seat portion is the same, the set value becomes larger as the set discharge pressure increases.

6. The method of manufacturing the fuel supply pump according to claim 4,
wherein the set discharge pressure is set to 30 MPa or more.

7. The method of manufacturing the fuel supply pump according to claim 5,
wherein the seat angle of the seat portion is set to be between 40° and 50°.

8. The method of manufacturing the fuel supply pump according to claim 2,
wherein the relief valve mechanism is configured such that a pressure difference between a pressure on the discharge side of the pressurizing chamber and a pressure of the pressurizing chamber becomes larger than the set valve opening pressure, and
wherein the set discharge pressure is set as a maximum pressure value on the discharge side of the pressurizing chamber in a suction stroke.

9. The method of manufacturing the fuel supply pump according to claim 2,
wherein the relief valve mechanism is configured such that a pressure difference between a pressure on the discharge side of the pressurizing chamber and a pressure on a suction side of the pressurizing chamber becomes larger than the set valve opening pressure, and
wherein the set discharge pressure is set as a maximum pressure value on the discharge side of the pressurizing chamber in a compression stroke.

10. The method of manufacturing the fuel supply pump according to claim 3,
wherein the relief valve mechanism is configured such that a pressure difference between a pressure on the discharge side of the pressurizing chamber and a pressure of the pressurizing chamber becomes larger than the set valve opening pressure, and
wherein the set discharge pressure is set as a maximum pressure value on the discharge side of the pressurizing chamber in a suction stroke.

11. The method of manufacturing the fuel supply pump according to claim 3,
wherein the relief valve mechanism is configured such that a pressure difference between a pressure on the discharge side of the pressurizing chamber and a pressure on a suction side of the pressurizing chamber becomes larger than the set valve opening pressure, and
wherein the set discharge pressure is set as a maximum pressure value on the discharge side of the pressurizing chamber in a compression stroke.
